(19) United States
(12) Patent Application Publication
(10) Pub. No.: US 2026/0320773 A1
(43) Pub. Date: Oct. 15, 2026

(54) ANOMALY DETECTING APPARATUS, METHOD, AND NON-TRANSITORY COMPUTER READABLE MEDIUM

(71) Applicant: KABUSHIKI KAISHA TOSHIBA, Kawasaki-shi Kanagawa (JP)

(72) Inventors: Kentaro TAKAGI, Yokohama Kanagawa (JP); Toshiyuki OSHIMA, Tokyo (JP); Kouta NAKATA, Chigasaki Kanagawa (JP)

(73) Assignee: KABUSHIKI KAISHA TOSHIBA, Kawasaki-shi Kanagawa (JP)

(21) Appl. No.: 19/444,891

(22) Filed: Jan. 9, 2026

(30) Foreign Application Priority Data
Jan. 14, 2025 (JP) 2025-004972

(51) Int. Cl. G06T 7/00; G06V 10/82

(52) U.S. Cl. CPC G06T 7/001; G06V 10/82; G06T 2207/30148

(57) ABSTRACT

According to one embodiment, an anomaly detecting apparatus includes a processor. The processor divides a training image into a plurality of patch images by a dividing method. The processor allots the patch images to a plurality of regions by an allotting method. The processor extracts features with a neural network from the respective allotted patch images in the respective regions. The processor samples a partial feature from among the respective extracted features, based on similarity between the respective extracted features. The processor generates an anomaly detecting model storing the sampled partial feature. The processor calculates an anomaly score for an inference image, using the anomaly detecting model generated in each of the regions.

### CROSS-REFERENCE TO RELATED APPLICATION

This application is based upon and claims the benefit of priority from Japanese Patent Application No. 2025-004972, filed Jan. 14, 2025, the entire contents of which are incorporated herein by reference.

### FIELD

Embodiments described herein relate generally to an anomaly detecting apparatus, a method, and a non-transitory computer readable medium.

### BACKGROUND

At the manufacturing site of a product using a semiconductor, an anomaly (or a defect) is detected from an image of the product by a method combining a manual technique and an automated technique (for example, visual observation and artificial intelligence). To detect anomalies from images of all products, a large labor cost is required. To reduce the labor cost, high-speed anomaly detecting methods are being developed.

However, an image of a product has high resolution (for example, 10,000×10,000 pixels). Therefore, anomalies are not detected from product images at high speed by an anomaly detecting method using the deep neural network (DNN).

### BRIEF DESCRIPTION OF DRAWINGS

FIG. 1 is a functional configuration diagram of an anomaly detecting apparatus according to a first embodiment.

FIG. 2 is a flowchart of training of anomaly detecting models according to the first embodiment.

FIG. 3 is a detailed diagram related to the training flow shown in FIG. 2.

FIG. 4 is a flowchart of inference of anomaly detecting models according to the first embodiment.

FIG. 5 is a detailed diagram related to the inference flow shown in FIG. 4.

FIG. 6 is a functional configuration diagram of an anomaly detecting apparatus according to a second embodiment.

FIG. 7 is a flowchart of training of anomaly detecting models according to the second embodiment.

FIG. 8 is a flowchart of inference of anomaly detecting models according to the second embodiment.

FIG. 9 is a hardware configuration diagram of an anomaly detecting apparatus according to each embodiment.

### DETAILED DESCRIPTION

In general, according to one embodiment, an anomaly detecting apparatus includes a processor. The processor divides a training image into a plurality of patch images by a dividing method. The processor allots the patch images to a plurality of regions by an allotting method. The processor extracts features with a neural network from the respective allotted patch images in the respective regions. The processor samples a partial feature from among the respective extracted features, based on similarity between the respective extracted features. The processor generates an anomaly detecting model storing the sampled partial feature. The processor calculates an anomaly score for an inference image, using the anomaly detecting model generated in each of the regions.

The following is a description of each embodiment, with reference to the drawings. A plurality of portions denoted by the same reference numerals are regarded as the same, and repetitive descriptions are omitted as appropriate.

### First Embodiment

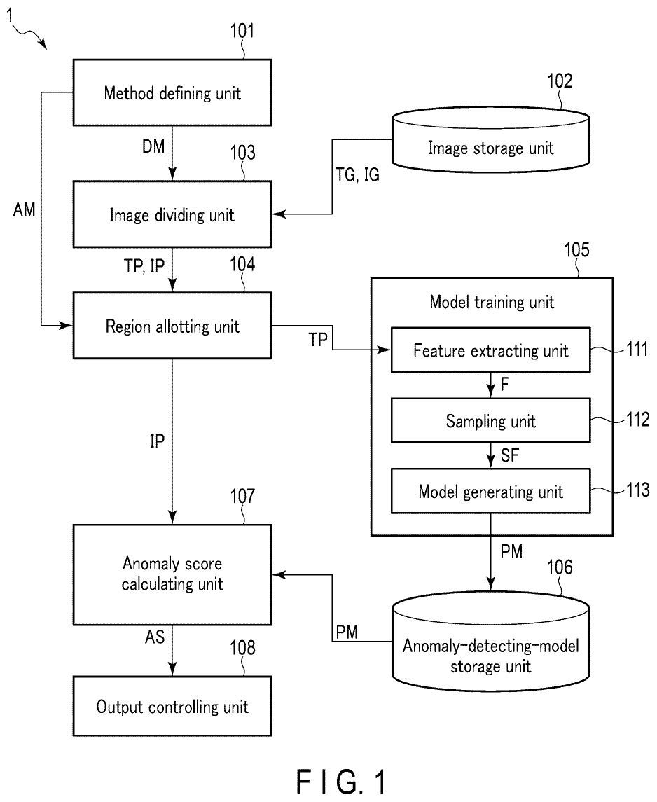

FIG. 1 is a functional configuration diagram of an anomaly detecting apparatus 1 according to a first embodiment. The anomaly detecting apparatus 1 is an apparatus that detects an anomaly. The anomaly detecting apparatus 1 includes a method defining unit 101, an image storage unit 102, an image dividing unit 103, a region allotting unit 104, a model training unit 105, an anomaly-detecting-model storage unit 106, an anomaly score calculating unit 107, and an output controlling unit 108.

The method defining unit 101 is a means that defines a method. For example, the method defining unit 101 defines a dividing method DM and an allotting method AM for images. The method defining unit 101 transmits the defined dividing method DM to the image dividing unit 103, and transmits the defined allotting method AM to the region allotting unit 104.

The image storage unit 102 is a means that stores images. For example, the image storage unit 102 stores images (in particular, images having a high resolutions) of a product using a semiconductor. The image storage unit 102 stores a training image TG for training of a model, and stores an inference image IG for inference of a model. The image storage unit 102 transmits the stored training image TG and inference image IG to the image dividing unit 103.

Note that the training image TG and the inference image IG may be images obtained by imaging different products belonging to the same type (or lot). The images are also referred to as “inspection images” for performing inspection for an anomaly that might exist in a product. The training image TG may be used as the inference image IG, or the inference image IG may be used as the training image TG.

The image dividing unit 103 is a means that divides images. For example, the image dividing unit 103 receives the dividing method DM from the method defining unit 101, and receives the training image TG and the inference image IG from the image storage unit 102. The image dividing unit 103 divides the training image TG and the inference image IG into a plurality of patch images (which are partial images) by the dividing method DM. The image dividing unit 103 transmits the patch images (also referred to as the “training patch images TP”) divided from the training image TG, to the region allotting unit 104. The image dividing unit 103 transmits the patch images (also referred to as the “inference patch images IP”) divided from the inference image IG, to the region allotting unit 104.

The region allotting unit 104 is a means that allots (or groups) the patch images to a plurality of regions.

For example, the region allotting unit 104 receives the allotting method AM from the method defining unit 101, and receives the training patch images TP and the inference patch images IP from the image dividing unit 103. The region allotting unit 104 allots the training patch images TP and the inference patch images IP to the regions (which are partial regions) by the allotting method AM. The region allotting unit 104 transmits the allotted training patch images TP to the model training unit 105. The region allotting unit 104 transmits the allotted inference patch images IP to the anomaly score calculating unit 107.

Note that the training patch images TP and the inference patch images IP may have region information indicating the regions to which the respective images are allotted, as properties.

The model training unit 105 is a means that trains models. For example, the model training unit 105 receives the training patch images TP allotted to the regions, from the region allotting unit 104. The model training unit 105 trains a plurality of anomaly detecting models (also referred to as “partial-region anomaly detecting models PM”) corresponding to the regions, using the training patch images TP. The model training unit 105 transmits the trained partial-region anomaly detecting models PM to the anomaly-detecting-model storage unit 106. The model training unit 105 includes a feature extracting unit 111, a sampling unit 112, and a model generating unit 113.

In particular, the model training unit 105 trains the anomaly detecting models corresponding respectively to the partial regions of the training image TG, using the Patchcore method (see Non-Patent Literature 1: Karsten Roth et al., “Towards Total Recall in Industrial Anomaly Detection”, Proceedings of the 2022 IEEE/CVF Conference on Computer Vision and Pattern Recognition (CVPR), 2022, pp. 14298-14308). The Patchcore method trains one anomaly detecting model corresponding to the entire region of an image. The anomaly detecting model has a pre-trained neural network (a convolutional neural network (CNN), for example) and a memory bank. The anomaly detecting model extracts a feature from each of the images, using the neural network. Next, the anomaly detecting model samples some features from the extracted respective features by Coreset sampling. The anomaly detecting model then stores the sampled some features into the memory bank.

The feature extracting unit 111 is a means that extracts features F (or a feature vector). For example, the feature extracting unit 111 receives the training patch images TP allotted to the regions, from the region allotting unit 104. The feature extracting unit 111 extracts a feature F from each of the training patch images TP with the neural network, in each of the regions. That is, in one region, the feature extracting unit 111 extracts a feature F from each of the training patch images TP allotted to the region, using the neural network of the anomaly detecting model corresponding to the region. The feature extracting unit 111 repeats the same processing for each region. The feature extracting unit 111 transmits each of the extracted features F to the sampling unit 112.

The sampling unit 112 is a means that performs sampling. For example, the sampling unit 112 receives each of the features F from the feature extracting unit 111. The sampling unit 112 samples some features SF from the respective features F, based on the similarity between the respective features F. The sampling unit 112 may reduce the number of features F by eliminating a plurality of features F having a similarity equal to or higher than a threshold. The sampling unit 112 may perform Coreset sampling. The sampling unit 112 may repeat the same processing for each region. The sampling unit 112 transmits the sampled some features SF to the model generating unit 113.

The model generating unit 113 is a means that generates models. For example, the model generating unit 113 receives some features SF from the sampling unit 112. The model generating unit 113 generates partial-region anomaly detecting models PM, having the some features SF stored in the memory banks. The model generating unit 113 may repeat the same processing for each region. The model generating unit 113 transmits the generated partial-region anomaly detecting models PM to the anomaly-detecting-model storage unit 106.

The anomaly-detecting-model storage unit 106 is a means that stores anomaly detecting models. For example, the anomaly-detecting-model storage unit 106 receives and stores the partial-region anomaly detecting models PM from the model training unit 105. The anomaly-detecting-model storage unit 106 transmits the stored partial-region anomaly detecting models PM to the anomaly score calculating unit 107.

The anomaly score calculating unit 107 is a means that calculates anomaly scores AS. For example, the anomaly score calculating unit 107 receives the inference patch images IP allotted to the regions from the region allotting unit 104, and receives the partial-region anomaly detecting models PM generated for the respective regions from the anomaly-detecting-model storage unit 106. The anomaly score calculating unit 107 calculates anomaly scores AS for the inference patch images IP, using the partial-region anomaly detecting models PM. The anomaly score calculating unit 107 transmits the calculated anomaly scores AS to the output controlling unit 108.

In particular, the anomaly score calculating unit 107 calculates the anomaly scores AS, using the Patchcore method. Specifically, the anomaly score calculating unit 107 extracts features from the inference patch images IP, using the neural networks of the partial-region anomaly detecting models PM. Next, the anomaly score calculating unit 107 calculates the anomaly scores AS, based on the distances between the extracted features and the respective features stored in the memory banks of the partial-region anomaly detecting models PM. Accordingly, the anomaly score calculating unit 107 requires a larger number of calculations (or a longer calculation time) in a case where the number of features stored in the memory banks is larger.

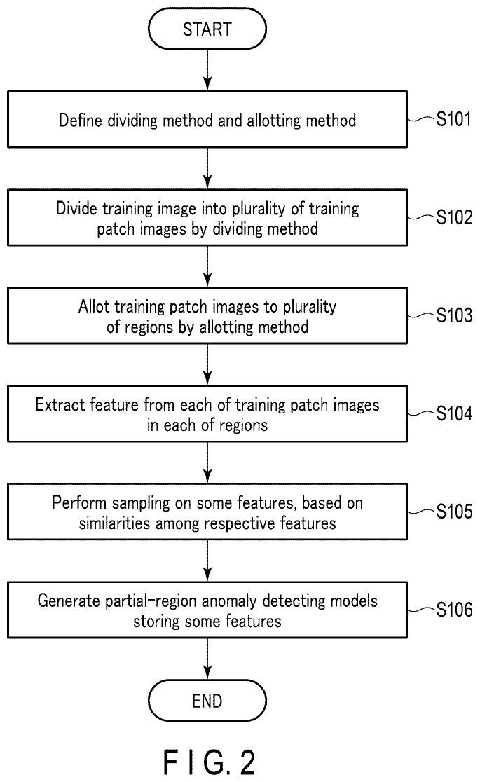

The output controlling unit 108 is a means that controls outputs. For example, the output controlling unit 108 receives the anomaly scores AS from the anomaly score calculating unit 107. The output controlling unit 108 generates output data for presenting the anomaly scores AS to the user. The output controlling unit 108 may output the generated output data to a display device. FIG. 2 is a flowchart of training of anomaly detecting models according to the first embodiment. The anomaly detecting apparatus 1 according to the first embodiment generates partial-region anomaly detecting models PM for the respective regions of the training image TG through steps S101 to S106.

(Step S101) First, the method defining unit 101 defines a dividing method DM and an allotting method AM. Specifically, the method defining unit 101 defines a dividing method DM and an allotting method AM for the training image TG stored in the image storage unit 102.

First, the method defining unit 101 defines a dividing method DM for dividing the training image TG into a plurality of training patch images TP. The method defining unit 101 may define the dividing method DM so as to allow an overlap between the training patch images TP. That is, an overlap region may be formed between two training patch images TP adjacent to each other.

Alternatively, the method defining unit 101 may define the dividing method DM, based on the size of the minimum defect in the training image TG. The method defining unit 101 may define the dividing method DM so that each of the training patch images TP is larger than the size of the minimum defect in the training image TG.

Note that the method defining unit 101 may define the dividing method DM, based on the structure of the neural networks included in the partial-region anomaly detecting models PM. For example, the method defining unit 101 defines the dividing method DM so that the number of neurons constituting the input layers of the neural networks is equal to the number of pixels constituting the training patch images TP. The method defining unit 101 may define the dividing method DM for dividing the training image TG into a grid-like form (or a patch-like form).

Secondly, the method defining unit 101 defines the allotting method AM for allotting the training patch images TP to a plurality of regions. The method defining unit 101 may define the allotting method AM so as to allow an overlap between the regions. That is, an overlap region may be formed between two regions adjacent to each other. Alternatively, the method defining unit 101 may define the allotting method AM so that some training patch images TP having features similar to each other among the training patch images TP belong to the same region. The method defining unit 101 may identify the some training patch images TP by clustering the plurality of training patch images TP by an existing method (k-means method, for example). The method defining unit 101 may calculate the similarity between the training patch images TP in a feature space.

Note that the method defining unit 101 may define the allotting method AM so that the training patch images TP are equally divided into n (n: a natural number of 2 or greater) in a vertical direction (or a horizontal direction). The method defining unit 101 may divide the training image TG into a plurality of regions by dividing the training image TG into four equal parts (or nine equal parts) in the vertical direction (or the horizontal direction). The method defining unit 101 may define the allotting method AM so that the training patch images TP are allotted to three different regions (a left region, a central region, and a right region, for example) in the vertical direction.

(Step S102) Next, the image dividing unit 103 divides the training image TG into a plurality of training patch images TP by the dividing method DM.

Specifically, the image dividing unit 103 acquires the training image TG from the image storage unit 102. The image dividing unit 103 divides the acquired training image TG into a plurality of training patch images TP by the dividing method DM defined in step S101.

(Step S103) The region allotting unit 104 then allots the training patch images TP to a plurality of regions by the allotting method AM. Specifically, the region allotting unit 104 allots the training patch images TP obtained in step S102 to a plurality of regions by the allotting method AM defined in step S101.

(Step S104) The feature extracting unit 111 of the model training unit 105 then extracts features F from the respective training patch images TP in each of the regions. Specifically, the feature extracting unit 111 extracts the features F from the respective training patch images TP obtained in step S102, for each of the regions to which the training patch images TP have been allotted in step S103.

(Step S105) The sampling unit 112 of the model training unit 105 then samples some features SF, based on the similarity between the respective features F. Specifically, the sampling unit 112 samples some features SF, based on the similarity between the respective features F extracted in step S104.

(Step S106) Lastly, the model generating unit 113 of the model training unit 105 generates partial-region anomaly detecting models PM storing the some features SF. Specifically, the model generating unit 113 generates partial-region anomaly detecting models PM in which the some features SF sampled in step S105 are stored in the memory banks. The model generating unit 113 stores the generated partial-region anomaly detecting models PM into the anomaly-detecting-model storage unit 106.

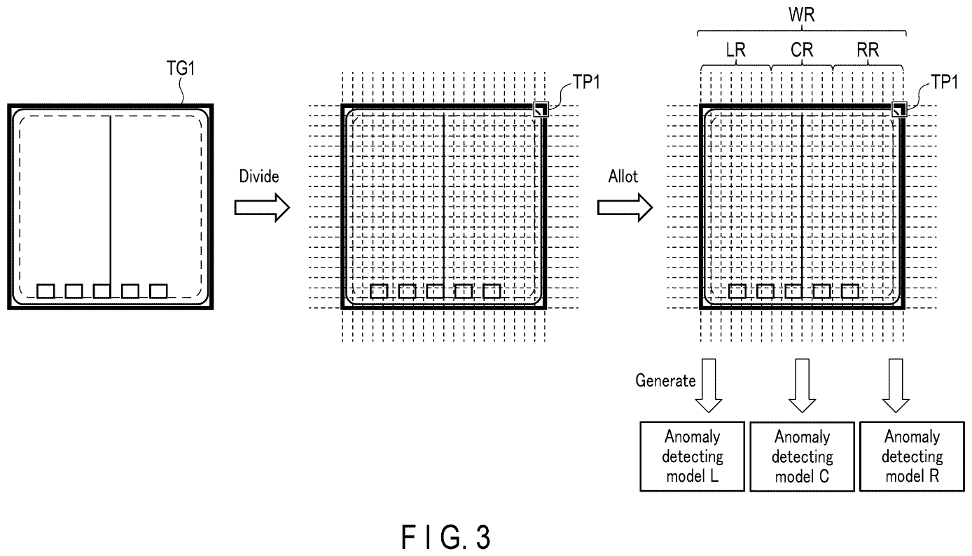

FIG. 3 is a detailed diagram related to the training flow shown in FIG. 2. A training image TG1 is an inspection image of 100 million pixels (10,000×10,000 pixels) obtained by imaging a semiconductor chip. The training image TG1 is divided into 400 (20×20) training patch images TP1 in a grid-like form by the dividing method DM. The 400 training patch images TP1 are allotted to three different regions (a left region LR, a central region CR, and a right region RR) in the entire region WR of the training image TG1, by the allotting method AM.

The left region LR includes 140 training patch images TP1 belonging to the seven columns on the left side. The central region CR includes 120 training patch images TP1 belonging to the six columns in the center. The right region RR includes 140 training patch images TP1 belonging to the seven columns on the right side.

The 140 training patch images TP1 belonging to the left region LR are used to generate a partial-region anomaly detecting model PM (also referred to as an “anomaly detecting model L”) corresponding to the left region LR. The 120 training patch images TP1 belonging to the central region CR are used to generate a partial-region anomaly detecting model PM (also referred to as an “anomaly detecting model C”) corresponding to the central region CR. The 140 training patch images TP1 belonging to the right region RR are used to generate a partial-region anomaly detecting model PM (also referred to as an “anomaly detecting model R”) corresponding to the right region RR.

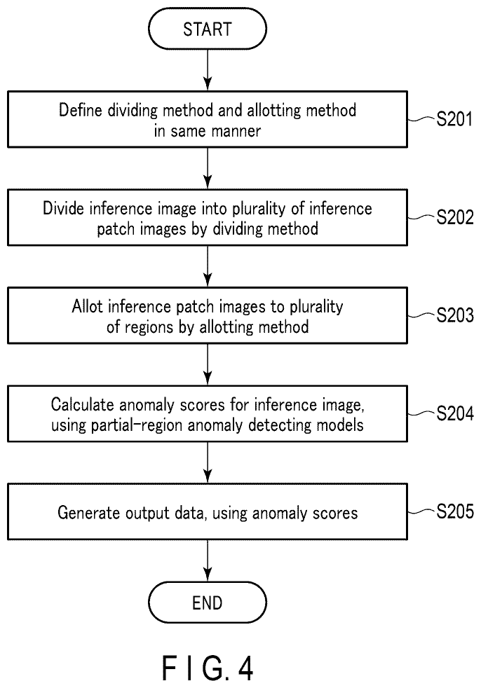

FIG. 4 is a flowchart of inference of anomaly detecting models according to the first embodiment. The anomaly detecting apparatus 1 according to the first embodiment applies the partial-region anomaly detecting models PM to the respective regions of the inference image IG, and calculates anomaly scores AS for the inference image IG, through steps S201 to S205. The anomaly detecting apparatus 1 generates output data using the anomaly scores AS.

(Step S201) First, the method defining unit 101 defines a dividing method DM and an allotting method AM in similar manners. Specifically, the method defining unit 101 defines the dividing method DM and the allotting method AM for the inference image IG stored in the image storage unit 102 in similar manners. The method defining unit 101 defines the same dividing method DM and allotting method AM as those defined in step S101 (see FIG. 2).

(Step S202) Next, the image dividing unit 103 divides the inference image IG into a plurality of inference patch images IP by the dividing method DM.

Specifically, the image dividing unit 103 acquires the inference image IG from the image storage unit 102. The image dividing unit 103 divides the acquired inference image IG into a plurality of inference patch images IP by the dividing method DM defined in step S201.

(Step S203) The region allotting unit 104 then allots the inference patch images IP to a plurality of regions by the allotting method AM. Specifically, the region allotting unit 104 allots the inference patch images IP obtained in step S202 to a plurality of regions by the allotting method AM defined in step S201.

(Step S204) The anomaly score calculating unit 107 calculates anomaly scores AS for the inference image IG, using the partial-region anomaly detecting models PM.

Specifically, the anomaly score calculating unit 107 applies the partial-region anomaly detecting models PM generated in step S106 (see FIG. 2) to the respective regions to which the inference patch images IP have been allotted in step S203. The anomaly score calculating unit 107 calculates anomaly scores AS for the inference patch images IP.

(Step S205) Lastly, the output controlling unit 108 generates output data using the anomaly scores AS. Specifically, the output controlling unit 108 generates output data for presenting the anomaly scores AS calculated in step S204 to the user. The output data may be the inference patch images IP arranged in parallel in descending order of the anomaly scores AS. The output data may be the inference patch images IP that have higher anomaly scores AS than a threshold and are arranged in parallel (or emphasized). The output data may be displayed to the user with a display device.

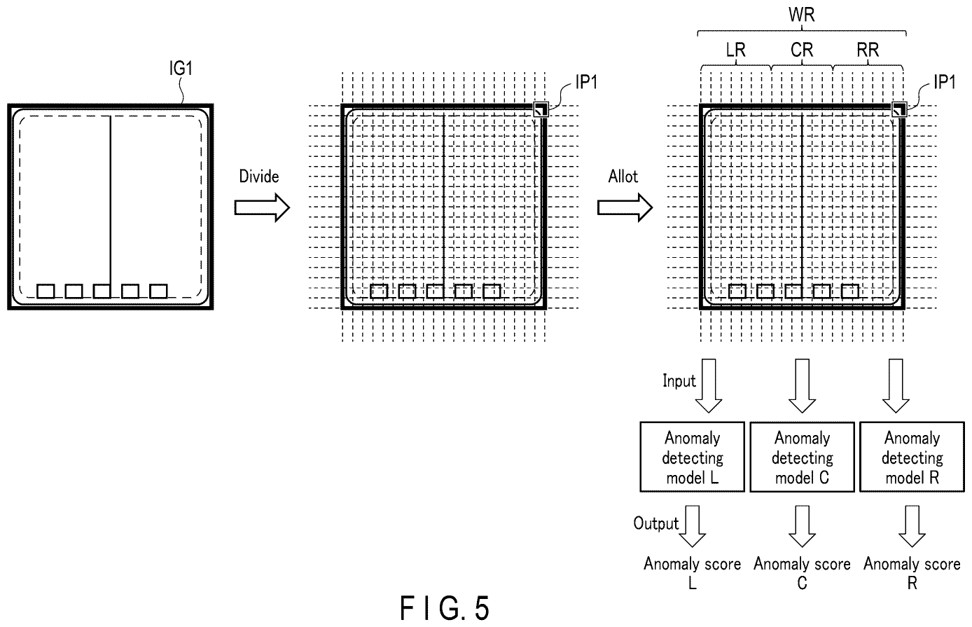

FIG. 5 is a detailed diagram related to the inference flow shown in FIG. 4. An inference image IG1 is an inspection image of 100 million pixels (10,000×10,000 pixels) obtained by imaging a semiconductor chip. The inference image IG1 is divided into 400 (20×20) inference patch images IP1 in a grid-like form by the dividing method DM. The 400 inference patch images IP1 are allotted to three different regions (a left region LR, a central region CR, and a right region RR) in the entire region WR of the inference image IG1, by the allotting method AM. That is, the 400 inference patch images IP1 are allotted to three different regions, like the 400 training patch images TP1 (see FIG. 3).

The 140 inference patch images IP1 belonging to the left region LR are input to the anomaly detecting model L corresponding to the left region LR. The anomaly detecting model L outputs an anomaly score L corresponding to the left region LR. The 120 inference patch images IP1 belonging to the central region CR are input to the anomaly detecting model C corresponding to the central region CR. The anomaly detecting model C outputs an anomaly score C corresponding to the central region CR. The 140 inference patch images IP1 belonging to the right region RR are input to the anomaly detecting model R corresponding to the right region RR. The anomaly detecting model R outputs an anomaly score R corresponding to the right region RR.

Note that each of the anomaly score L, the anomaly score C, and the anomaly score R may be an anomaly score for each of the inference patch images IP1, or may be a statistical value (median or mean, for example) for the anomaly scores. Each of the anomaly score L, the anomaly score C, and the anomaly score R may be the anomaly score AS for the inference image IG1. The statistical value (median or mean, for example) for the anomaly score L, the anomaly score C, and the anomaly score R may be the anomaly score AS for the inference image IG1.

In the anomaly detecting apparatus 1 according to the first embodiment described above, the image dividing unit 103 divides the training image TG into a plurality of training patch images TP. The region allotting unit 104 allots the training patch images TP to the respective regions. The model training unit 105 trains anomaly detecting models for the respective regions by the Patchcore method. The anomaly score calculating unit 107 calculates the anomaly score AS for the inference image IG, using the anomaly detecting models trained for the respective regions.

In general, by the Patchcore method, the speed of inference processing by an anomaly detecting model is lower in a case where the amount of training data (which is patch images) used for the training of the anomaly detecting model is larger. Therefore, the anomaly detecting apparatus 1 does not train one anomaly detecting model for the training image TG, but divides the training image TG into a plurality of regions and trains a plurality of anomaly detecting models corresponding to the respective regions. As a result, the anomaly detecting apparatus 1 reduces the amount of training data for each of the anomaly detecting models, with respect to the amount of training data for the one anomaly detecting model. Thus, the anomaly detecting apparatus 1 can detect an anomaly from an image (in particular, the inference image IG) at high speed, using the plurality of anomaly detecting models.

Furthermore, by the Patchcore method, the speed of inference processing by an anomaly detecting model is lower in a case where the number of features F stored in the memory bank of the anomaly detecting model is larger. Therefore, the anomaly detecting apparatus 1 reduces the number of features F to be stored in the memory bank, based on the similarity between the features F. Thus, the anomaly detecting apparatus 1 can detect an anomaly from an image (in particular, the inference image IG) at high speed, using anomaly detecting models storing a smaller number of features F.

### Second Embodiment

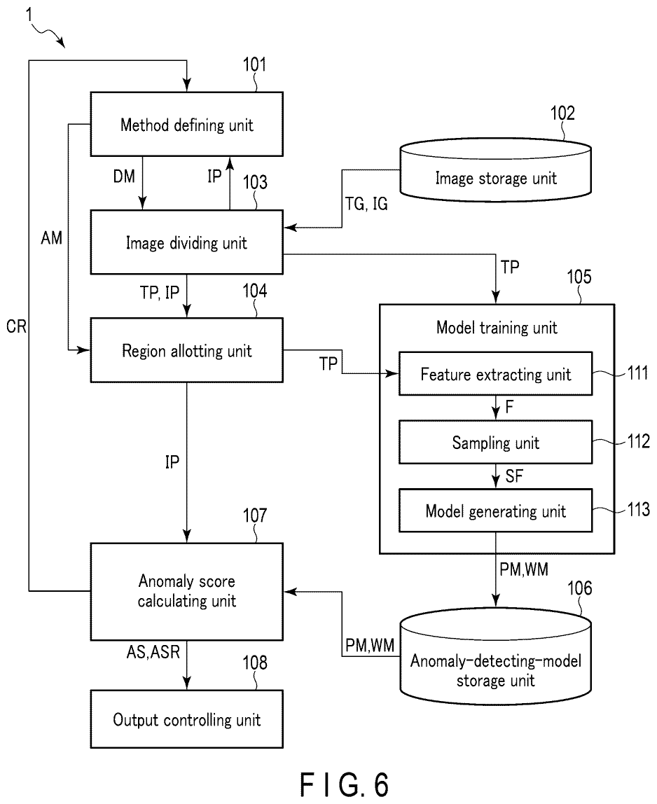

FIG. 6 is a functional configuration diagram of an anomaly detecting apparatus 1 according to a second embodiment. The anomaly detecting apparatus 1 according to the second embodiment has the same configuration as that of the first embodiment, and operates in the same manner as in the first embodiment. Further, the anomaly detecting apparatus 1 according to the second embodiment operates as follows.

An image dividing unit 103 transmits a plurality of training patch images TP to a model training unit 105. The image dividing unit 103 transmits a plurality of inference patch images IP to a method defining unit 101.

The model training unit 105 receives the plurality of training patch images TP (which have not been allotted to a plurality of regions by a region allotting unit 104) from the image dividing unit 103. The model training unit 105 trains an anomaly detecting model (also referred to as a “whole-region anomaly detecting model WM”) corresponding to the entire regions (which are the entire region of a training image TG) by the Patchcore method, using the training patch images TP. The model training unit 105 transmits the trained whole-region anomaly detecting model WM to an anomaly-detecting-model storage unit 106.

A feature extracting unit 111 receives the training patch images TP from the image dividing unit 103. The feature extracting unit 111 extracts the features F from each of the training patch images TP with a neural network, in the entire regions (described above). The feature extracting unit 111 extracts the features F by the same method as that of the first embodiment. The feature extracting unit 111 transmits each of the extracted features F to a sampling unit 112.

The sampling unit 112 receives each of the features F from the feature extracting unit 111. The sampling unit 112 samples some features SF from the respective features F, based on the similarity between the respective features F. The sampling unit 112 performs sampling by the same method as that of the first embodiment. The sampling unit 112 transmits the sampled some features SF to a model generating unit 113.

The model generating unit 113 receives the some features SF from the sampling unit 112. The model generating unit 113 generates the whole-region anomaly detecting model WM in which the some features SF are stored in a memory bank. The model generating unit 113 generates the whole-region anomaly detecting model WM by the same method as that of the first embodiment. The model generating unit 113 transmits the generated whole-region anomaly detecting model WM to the anomaly-detecting-model storage unit 106.

An anomaly score calculating unit 107 receives the inference patch images IP allotted to the plurality of regions from the region allotting unit 104, and receives a plurality of partial-region anomaly detecting models PM and the whole-region anomaly detecting model WM from the anomaly-detecting-model storage unit 106. The anomaly score calculating unit 107 calculates anomaly scores AS for the inference patch images IP, using the partial-region anomaly detecting models PM. The anomaly score calculating unit 107 calculates an anomaly score (also referred to as “the other anomaly score ASR”) for the inference patch images IP, using the whole-region anomaly detecting model WM.

Further, the anomaly score calculating unit 107 calculates a difference between the anomaly score AS for the inference image IG and the other anomaly score ASR.

In a case where the difference is larger than a threshold (difference>threshold), the anomaly score calculating unit 107 transmits a change instruction CR to the method defining unit 101. In a case where the difference is equal to or smaller than the threshold (difference≤threshold), the anomaly score calculating unit 107 transmits the anomaly score AS and the other anomaly score ASR to an output controlling unit 108.

The method defining unit 101 receives the change instruction CR from the anomaly score calculating unit 107. The method defining unit 101 redefines the allotting method AM, in response to the change instruction CR. The method defining unit 101 transmits the redefined allotting method AM to the region allotting unit 104.

For example, the method defining unit 101 receives a plurality of inference patch images IP from the image dividing unit 103. Next, the method defining unit 101 identifies an inference patch image IP having a larger difference (described above) than the threshold, from the plurality of inference patch images IP. The method defining unit 101 then identifies another inference patch image IP having a feature similar to that of the identified inference patch image IP. Lastly, the method defining unit 101 redefines the allotting method AM so that the identified inference patch image IP and another inference patch image IP belong to the same region.

Note that the region allotting unit 104 may allot the training patch images TP to a plurality of regions by the redefined allotting method AM. The model training unit 105 may train a plurality of partial-region anomaly detecting models PM corresponding to the respective regions. In this manner, a plurality of partial-region anomaly detecting models PM may be retrained, based on a redefined allotting method AM.

Note that the anomaly score calculating unit 107 may newly calculate an anomaly score AS, using the retrained partial-region anomaly detecting models PM. The anomaly score calculating unit 107 may newly calculate a difference between the anomaly score AS and the other anomaly score ASR.

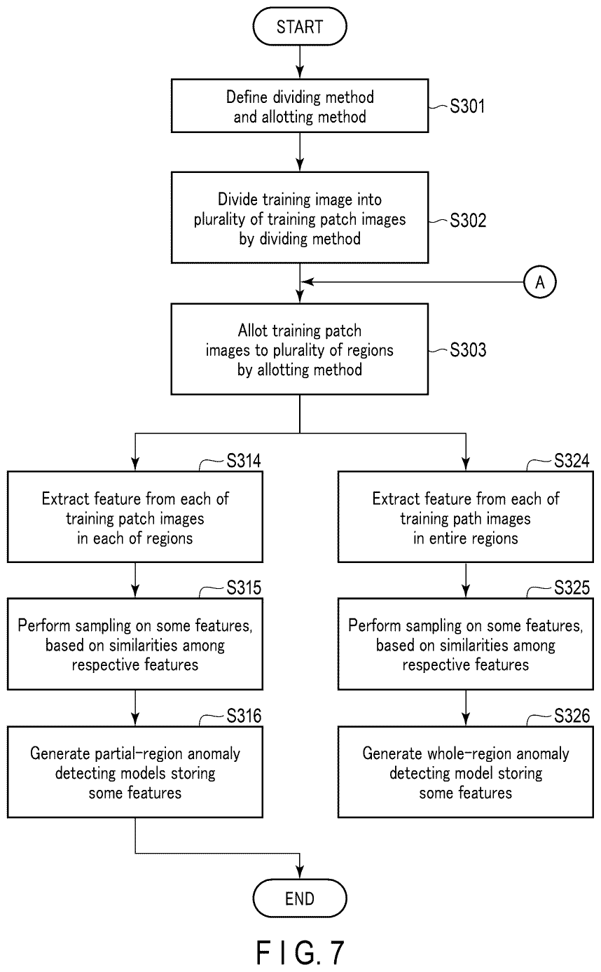

FIG. 7 is a flowchart of training of anomaly detecting models according to the second embodiment. The anomaly detecting apparatus 1 according to the second embodiment generates the partial-region anomaly detecting models PM for the respective regions of the training image TG, and generates the whole-region anomaly detecting model WM for the entire region of the training image TG, through steps S301 to S326.

(Steps S301 to S303) Steps S301, S302, and S303 are the same as steps S101, S102, and S103 (see FIG. 2), respectively.

(Steps S314 to S316) Steps S314, S315, and S316 are the same as steps S104, S105, and S106 (see FIG. 2), respectively.

(Step S324) On the other hand, the feature extracting unit 111 of the model training unit 105 extracts features F from the respective training patch images TP in the entire regions. Specifically, the feature extracting unit 111 extracts the features F from the respective training patch images TP obtained in step S302, for the entire regions to which the training patch images TP have been allotted in step S303.

(Step S325) The sampling unit 112 of the model training unit 105 then samples some features SF, based on the similarity between the respective features F. Specifically, the sampling unit 112 samples some features SF, based on the similarity between the respective features F extracted in step S324.

(Step S326) Lastly, the model generating unit 113 of the model training unit 105 generates the whole-region anomaly detecting model WM storing the some features SF. Specifically, the model generating unit 113 generates the whole-region anomaly detecting model WM in which the some features SF sampled in step S325 are stored in the memory bank. The model generating unit 113 stores the generated whole-region anomaly detecting model WM into the anomaly-detecting-model storage unit 106.

Note that steps S324 to S326 may be performed in parallel with steps S314 to S316. Steps S324 to S326 may be performed before (or after) steps S314 to S316, or may be performed between steps S302 and S303.

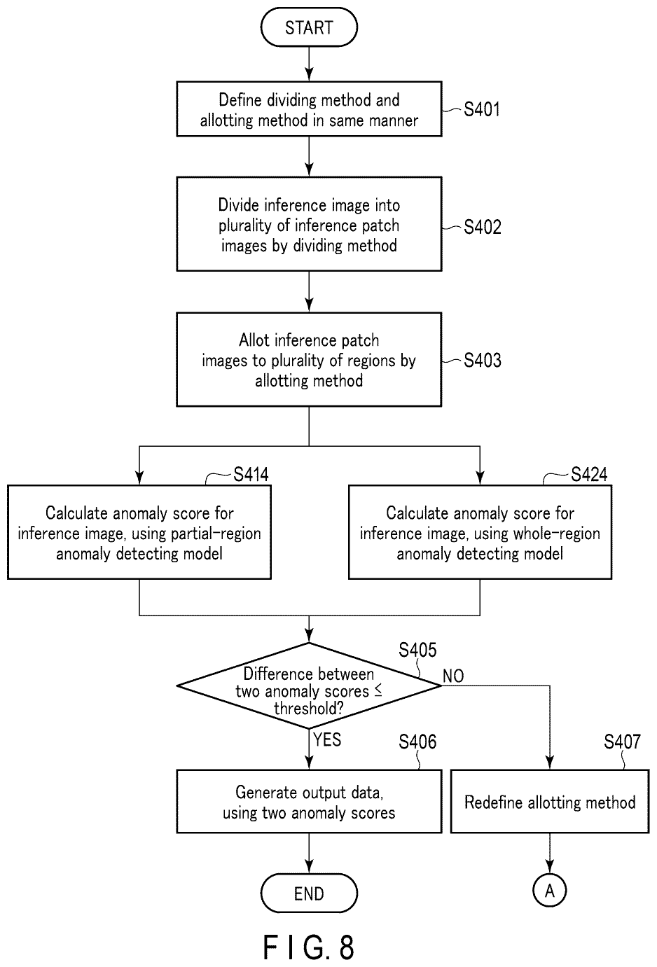

FIG. 8 is a flowchart of inference of anomaly detecting models according to the second embodiment. The anomaly detecting apparatus 1 according to the second embodiment applies the partial-region anomaly detecting models PM and the whole-region anomaly detecting model WM to the inference image IG, and calculates the anomaly score AS and the other anomaly score ASR for the inference image IG, through steps S401 to S407.

(Steps S401 to S403) Steps S401, S402, and S403 are the same as steps S201, S202, and S203 (see FIG. 4), respectively.

(Step S414) The anomaly score calculating unit 107 calculates the anomaly score AS for the inference image IG, using the partial-region anomaly detecting models PM. Step S414 is the same as step S204 (see FIG. 4).

(Step S424) The anomaly score calculating unit 107 calculates the other anomaly score ASR for the inference image IG, using the whole-region anomaly detecting model WM. Specifically, the anomaly score calculating unit 107 applies the whole-region anomaly detecting model WM generated in step S326 (see FIG. 7) to the respective regions to which the inference patch images IP have been allotted in step S403. The anomaly score calculating unit 107 calculates the other anomaly score ASR for the inference patch images IP.

Note that step S424 may be performed in parallel with step S414. Step S424 may be performed before (or after) step S414.

(Step S405) The anomaly score calculating unit 107 determines whether the difference between the two anomaly scores is equal to or smaller than the threshold (difference<threshold). Specifically, the anomaly score calculating unit 107 determines whether the difference between the anomaly score AS calculated in step S414 and the other anomaly score ASR calculated in step S424 is equal to or smaller than the threshold. If the difference is equal to or smaller than the threshold (YES in step S405), the process moves on to step S406. If the difference is larger than the threshold (NO in step S405), the process moves on to step S407.

(Step S406) Lastly, the output controlling unit 108 generates output data, using the two anomaly scores. Specifically, the output controlling unit 108 generates output data for presenting at least one of the anomaly score AS calculated in step S414 and the other score ASR calculated in step S424 to the user. The output data may be the inference patch images IP arranged in parallel in descending order of the other anomaly score ASR. The output data may be the inference patch images IP that are higher in the other anomaly score ASR than the threshold and are arranged in parallel (or emphasized). The output data may be displayed to the user with a display device.

(Step S407) On the other hand, the method defining unit 101 redefines the allotting method AM. Specifically, the method defining unit 101 redefines the allotting method AM defined in step S401. After step S407, the process returns to step S303 (see FIG. 7).

In the anomaly detecting apparatus 1 according to the second embodiment described above, the model training unit 105 trains an anomaly detecting model for the entire region of the training image TG by the Patchcore method. The anomaly score calculating unit 107 calculates the other anomaly score AS for the inference image IG, using the trained anomaly detecting model.

In general, by the Patchcore method, the accuracy of inference processing by an anomaly detecting model is higher in a case where the amount of training data (which is patch images) used for the training of the anomaly detecting model is larger. Therefore, the anomaly detecting apparatus 1 trains the whole-region anomaly detecting model WM, using training data that is larger in amount than the training data for the partial-region anomaly detecting models PM. The anomaly detecting apparatus 1 trains the partial-region anomaly detecting models PM so that the difference between the output (which is the anomaly score AS) from the partial-region anomaly detecting models PM and the output (which is the other anomaly score ASR) from the whole-region anomaly detecting model WM is equal to or smaller than the threshold. That is, the anomaly detecting apparatus 1 trains the partial-region anomaly detecting models PM so that the anomaly score AS matches the other anomaly score ASR. For example, in a case where the difference is larger than the threshold, the anomaly detecting apparatus 1 retrains the partial-region anomaly detecting models PM, based on the redefined allotting method AM. The anomaly detecting apparatus 1 can detect an anomaly from an image (in particular, the inference image IG) with high accuracy, using the partial-region anomaly detecting models PM retrained so that the difference becomes equal to or smaller than the threshold.

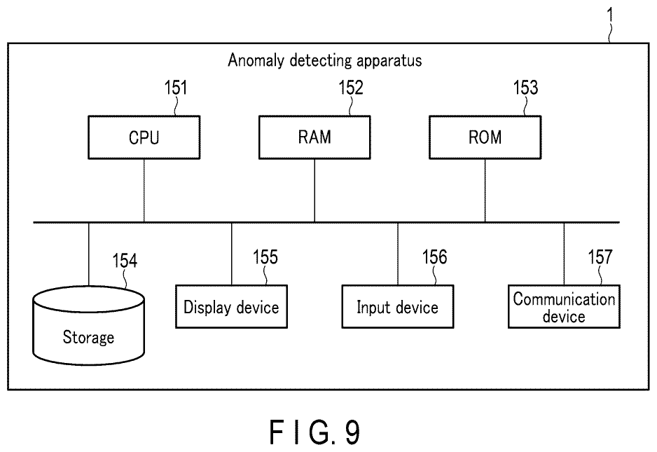

FIG. 9 is a hardware configuration diagram of the anomaly detecting apparatus 1 according to each embodiment. The anomaly detecting apparatus 1 includes a CPU 151, a RAM 152, a ROM 153, a storage 154, a display device 155, an input device 156, and a communication device 157 as the respective components. The respective components are communicably connected to one another by an internal bus. The anomaly detecting apparatus 1 may include at least some of the respective components.

The CPU 151 is a processor that executes various processes in accordance with a program. The CPU 151 uses a predetermined region in the RAM 152 as a work area. The CPU 151 reads and executes the respective programs stored in the ROM 153 or the storage 154, to implement the respective units (for example, the method defining unit 101, the image dividing unit 103, the region allotting unit 104, the model training unit 105, the anomaly score calculating unit 107, the output controlling unit 108, the feature extracting unit 111, the sampling unit 112, and the model generating unit 113). Each unit may be implemented by a dedicated hardware circuit (for example, an ASIC, a PLD, or an FPGA). Each unit may be implemented on premises or in a cloud. The CPU 151 is an example of a processing unit.

The RAM 152 is a memory that stores various kinds of data in a rewritable manner. For example, the RAM 152 is a synchronous dynamic random access memory (SDRAM). The ROM 153 is a memory that stores various kinds of data in a non-rewritable manner. The storage 154 is various kinds of storage media. The storage 154 may be a drive system that writes or reads various kinds of data into or from storage media. The RAM 152, the ROM 153, or the storage 154 is an example of a storage unit (for example, the image storage unit 102 or the anomaly-detecting-model storage unit 106).

The display device 155 is a device that displays various kinds of data. For example, the display device 155 is a liquid crystal display (LCD). The display device 155 displays various kinds of data, based on a display signal from the CPU 151. The display device 155 is an example of a display unit.

The input device 156 is a device that receives various input operations from the user. For example, the input device 156 is a mouse, a keyboard, or the like. The input device 156 receives an operation input by the user as an instruction signal, and transmits the instruction signal to the CPU 151. The input device 156 is an example of an input unit.

The communication device 157 communicates various kinds of data with an external device through a network. The communication device 157 is an example of a communication unit.

While certain embodiments have been described, these embodiments have been presented by way of example only, and are not intended to limit the scope of the inventions. Indeed, the novel embodiments described herein may be embodied in a variety of other forms;

furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anomaly detecting apparatus comprising a processor configured to:
divide a training image into a plurality of patch images by a dividing method;
allot the patch images to a plurality of regions by an allotting method;
extract features with a neural network from the respective allotted patch images in the respective regions;
sample a partial feature from among the respective extracted features, based on similarity between the respective extracted features;
generate an anomaly detecting model storing the sampled partial feature; and
calculate an anomaly score for an inference image, using the anomaly detecting model generated in each of the regions.

2. The anomaly detecting apparatus according to claim 1, wherein
the processor is configured to:
extract other features with the neural network from the respective patch images in the entire regions;
sample another partial feature from each of the extracted other features, based on similarity between the respective extracted other features;
generate another anomaly detecting model storing the sampled another partial feature; and
calculate another anomaly score for the inference image, using the another anomaly detecting model generated in the entire regions.

3. The anomaly detecting apparatus according to claim 2, wherein
the processor is configured to redefine the allotting method in a case where a difference between the anomaly score and the another anomaly score for the inference image is larger than a threshold.

4. The anomaly detecting apparatus according to claim 3, wherein
the processor is configured to:
identify a patch image larger in the difference than the threshold from the inference image;
identify another patch image having a feature similar to the patch image; and
redefine the allotting method to make the patch image and the another patch image belong to a same region.

5. The anomaly detecting apparatus according to claim 1, wherein
the processor is configured to define the dividing method to allow an overlap between the patch images.

6. The anomaly detecting apparatus according to claim 1, wherein
the processor is configured to define the dividing method to make each of the patch images larger than a size of a smallest defect in the training image.

7. The anomaly detecting apparatus according to claim 1, wherein
the processor is configured to define the allotting method to allow an overlap between the regions.

8. The anomaly detecting apparatus according to claim 1, wherein
the processor is configured to define the allotting method to make partial patch images having similar features among the patch images belong to a same region.

9. An anomaly detecting method for causing a computer to:
divide a training image into a plurality of patch images by a dividing method;
allot the patch images to a plurality of regions by an allotting method;
extract features with a neural network from the respective allotted patch images in the respective regions;
sample a partial feature from among the respective extracted features, based on similarity between the respective extracted features;
generate an anomaly detecting model storing the sampled partial feature; and
calculate an anomaly score for an inference image, using the anomaly detecting model generated in each of the regions.

10. A non-transitory computer readable medium including computer executable instructions, wherein the instructions, when executed by a processor, cause the processor to perform a method comprising:
dividing a training image into a plurality of patch images by a dividing method;
allotting the patch images to a plurality of regions by an allotting method;
extracting features with a neural network from the respective allotted patch images in the respective regions;
sampling a partial feature from among the respective extracted features, based on similarity between the respective extracted features;
generating an anomaly detecting model storing the sampled partial feature; and
calculating an anomaly score for an inference image, using the anomaly detecting model generated in each of the regions.
